(19) United States
(12) Patent Application Publication
(10) Pub. No.: US 2008/0094583 A1
(43) Pub. Date: Apr. 24, 2008

(54) Non-visible light control of active screen optical properties

(76) Inventors: R. Stanley Williams, Portola Valley, CA (US); Philip J. Kuekes, Menlo Park, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/584,476

(22) Filed: Oct. 19, 2006

(51) Int. Cl. G03B 21/26

(52) U.S. Cl. 353/94

(57) ABSTRACT

Techniques for modifying a visible projecting image are described. The technique includes using non-visible light to control optical properties of independent regions of an active screen. The non-visible light is capable of directly interacting with the regions of the active screen to modify an optical property of the regions of the active screen.

### BACKGROUND

Display and projection technology seeks to reproduce accurate and realistic renderings of images. The physical appearance of objects is a complex function of the objects surface properties, lighting conditions, and viewing angles. As photographers have known for decades, capturing realistic images is a challenge given the wide range of lighting and color variations that occur. Much advancement in imaging has been made over the last few decades, and extremely high quality images are available.

Even when good source images are available, the display or projection of images, however, presents another set of challenges. In particular, it is difficult to provide high quality images when the image is projected onto a screen. Problems with screens include less than desired contrast, limited viewing angle, and loss of resolution. As an example, in front projection it is difficult to simultaneously provide high reflectivity for light coming from a projector while also providing low reflectivity for ambient light. Other difficulties with screens include tradeoffs between brightness and viewing angle, brightness uniformity, contrast, color accuracy, and the like.

### BRIEF DESCRIPTION OF THE DRAWINGS

Features and advantages of the invention will be apparent from the detailed description which follows, taken in conjunction with the accompanying drawings, which together illustrate, by way of example, features of the invention; and, wherein:

FIG. 1 is an illustration of system for modifying a visible projected image using non-visible light to control optical properties of an active screen in accordance with an embodiment of the present invention;

FIG. 2 is a schematic diagram of a projector in accordance with an embodiment of the present invention;

FIG. 3 is a schematic diagram of an active screen in accordance with an embodiment of the present invention;

FIG. 4 is a block diagram of an active pixel for an active screen in accordance with an embodiment of the present invention; and

FIG. 5 is a flow chart of a method of modifying a visible projected image using non-visible light to control optical properties of an active screen in accordance with an embodiment of the present invention.

### DETAILED DESCRIPTION OF EXAMPLE EMBODIMENTS

In describing embodiments of the present invention, the following terminology will be used.

The singular forms “a,” “an,” and “the” include plural referents unless the context clearly dictates otherwise. Thus, for example, reference to “a pixel” includes reference to one or more of such pixels.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

As used herein, the term optical property when applied to an object refers to how the object affects the reflectance or transmission of light incident upon the object. Optical properties therefore include spectral reflectance, spectral transmittance, phase delay, polarization rotation, polarization reflectance profile, and scattering profile.

As used herein, the term optical characteristic refers to a property of light traveling through space. Optical characteristics therefore include intensity (measured on a total or spectral basis), phase, polarization, and coherence.

Reference will now be made to the exemplary embodiments illustrated, and specific language will be used herein to describe the same. It will nevertheless be understood that no limitation of the scope of the invention is thereby intended.

Traditionally, projected image reproduction has involved projecting the image onto a static screen. In front projection the screen is used in reflective mode, and in rear projection the screen is used in a transmissive mode. A typical front projection screen is a passive reflective surface designed to provide a diffuse reflection of light incident thereon. The design of a passive projection screen typically embodies multiple compromises. For example, as a screen is made more reflective to enable brighter images, the screen tends to reflect high amounts of ambient light, reducing the available dark levels and reducing contrast. As another example, a screen can be highly directional, reflecting only strongly light coming from the direction of a projector, but this tends to limit the viewing angle.

One example that illustrates the limitations of passive projection screens is an image of a night sky filled with stars. Most projection screens fail to provide a realistic rendering of the night sky, as inadequate contrast is available to provide a sufficiently dark background while providing realistically bright pin points of light.

It has been recognized that there is a need for improved ways of projecting images onto a screen. Accordingly, a technique for modifying a visible projected image using non-visible light to control optical properties of an active screen has been developed.

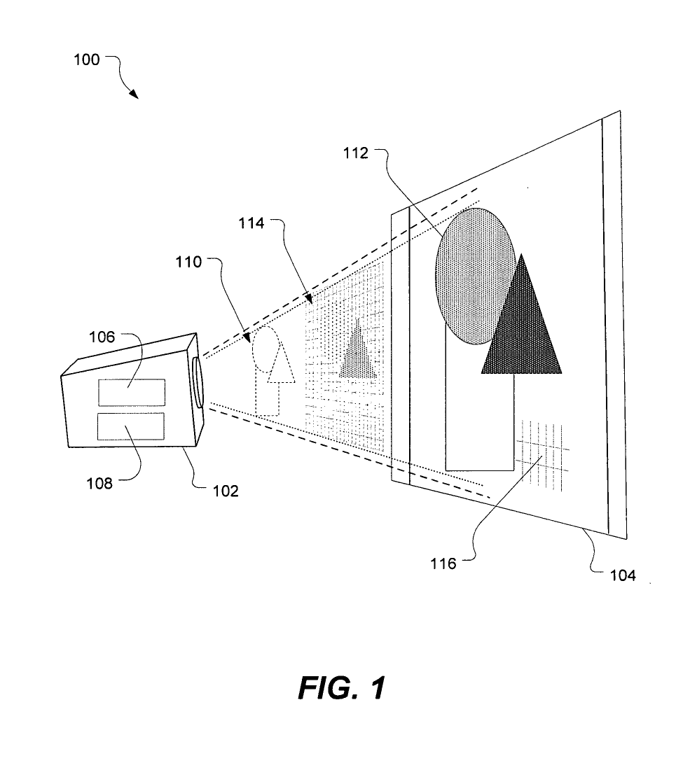

FIG. 1 illustrates a system in accordance with an embodiment of the present invention. The system, shown generally at 100, includes a projector 102 and an active screen 104. The projector can include a visible image projection subsystem 106 and a non-visible image projection subsystem 108. The visible image 110 is projected toward the active screen and reflected by (or, alternately, transmitted through) the active screen to produce a displayed image 112 on the active screen. The non-visible image 114 is projected toward the active screen and controls optical properties of independent active regions 116 of the active screen. For example, the active screen may include material which is responsive to an optical characteristic of the non-visible light incident thereon to change an optical property of the screen, such as spectral reflectance, spectral transmittance, or scattering profile. Accordingly, the appearance of the visible image is altered by the screen in a manner controlled by the non-visible image. Control of different active regions of the active screen is independent, so that the non-visible image can control optical properties of the screen differently for different portions of the displayed image.

For example, in an embodiment, the active screen may include a material which is photonically sensitive to non-visible radiation in the infrared region. The photonically-sensitive material may normally provide low reflectance within the visible spectrum band. Hence, the screen may normally appear dark. When illuminated by a sufficiently high intensity of infrared light, the photonically-sensitive material may undergo a chemical change which causes the material to provide high reflection of light within the visible spectrum band. Hence, the non-visible image can include infrared radiation in portions corresponding to bright areas of the visible image to help to increase brightness of the visible image without reducing contrast.

As another example, the non-visible light may be used to control optical properties of the active screen on a per pixel basis. For example, the projector may project a visible image composed of a plurality of visible pixels onto the screen. The non-visible image may include a plurality of non-visible pixels corresponding to the visible pixels. Each non-visible pixel may control the optical properties of screen in an area corresponding to the visible pixel.

Control over the optical properties of the screen may be discrete or continuous. For example, the non-visible image may act as an on-off switch, switching pixels or elements of the screen between reflective and non-reflective (or transmissive and non-transmissive) states. As another example, the control may be, for example, a reflectance level, adjusting screen pixels or elements over a range from essentially non-reflective (or non-transmissive) black to highly reflective (or highly-transmissive) white in proportion to the incident non-visible radiation.

The non-visible light may be infrared, ultraviolet, or light within the wavelength range of 300 nm to 700 nm having an average intensity or pulsed duty cycle sufficiently low so that the energy is not visible perceptible by a human observer. The non-visible light may be encoded to communicate information to the active screen, as described further below. The active screen may be responsive to the intensity, wavelength, spectral distribution, phase, polarization, or other optical characteristics of the non-visible light, as described further below. The optical properties of the active screen controlled by the non-visible light may be spectral reflectance, spectral transmittance, scattering profile, color, or other optical properties.

The non-visible light may be coded to encode data onto to non-visible light to communicate information to the active screen. For example, the non-visible light may be modulated using frequency modulation, amplitude modulation, or other techniques known in the art. As another example, the non-visible light may be pulse width or pulse position modulated. Different information may be encoded into each non-visible pixel to control the optical properties of the active screen on a pixel by pixel basis.

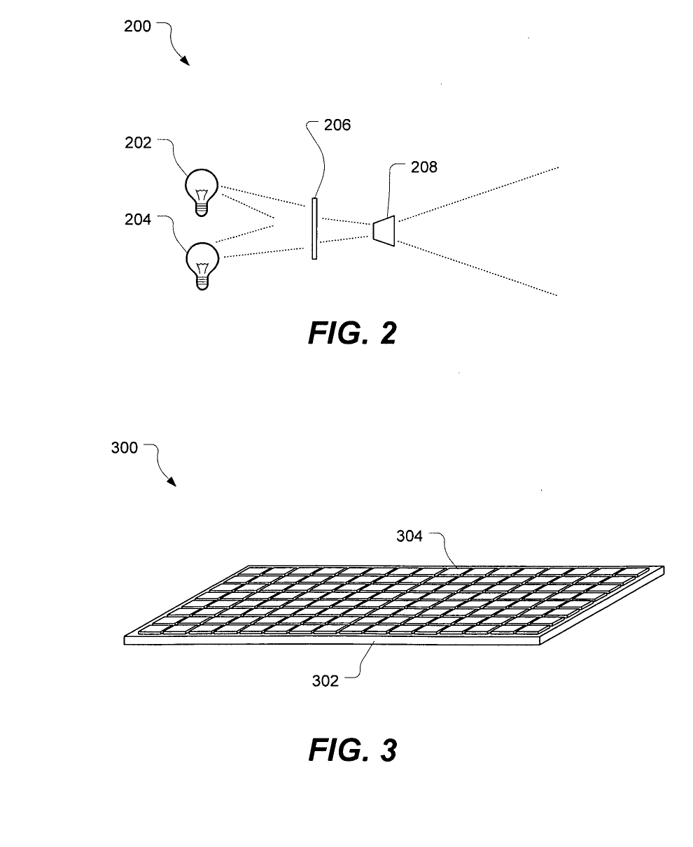

Various ways of implementing the projector are possible. FIG. 2 illustrates one embodiment of a projector 200. The projector can include one or more light sources, for example a visible light source 202 and a non-visible light source 204. An image can be formed using an image forming device 206 to form a plurality of pixels. The image forming device can be, for example, one or more digital mirror devices (DMD), grating light valves (GLV), liquid crystal on silicon (LCoS), or similar devices to form images. A single device may be used to sequentially modulate different component colors of visible and non-visible light, or multiple devices may be used to simultaneously modulate the different components. The visible light source may include a white light source and a color wheel, or the visible light source may include multiple colored light sources, or a combination thereof. Colored light sources may be provided, for example, by light emitting diodes or lasers. Optics 208 may be used to project the image (visible and non-visible components) onto an active screen.

FIG. 3 illustrates an active screen 300 in accordance with one embodiment of the present invention. The active screen may include a screen support structure 302 and a plurality of active regions 304 coupled to the screen support structure. While the screen generally presents a two-dimensional array of active regions, it will be appreciated that the screen need not be perfectly flat, and may be a curved surface. An active region can be responsive to non-visible light incident thereon to independently change an optical property of the active region based on an optical characteristic of the non-visible light incident on the active region.

For example, the active regions may correspond to pixels of the projected image, although this is not essential. Alternately, the active regions may be of dimensions substantially smaller than the pixels of the projected image. For example, each active region may be less than ⅕, 1/10, 1/100, or smaller proportion of the area of projected image pixel on the screen. For example, active regions may correspond to individual molecules of a photonically-sensitive material. As another example, active regions may correspond to micro electromechanical machines. Use of small active regions can help provide a screen which preserves the resolution of the projected image. Small active regions can also be compatible with varying projected image resolution. For example, the resolution of the displayed image can be defined by the number and size of pixels within the projected visible image, within the projected non-visible image, or a combination of both. Multiple active regions may fall within the area of one pixel of the displayed image, and thus respond similarly to the non-visible image.

The active regions 304 can be a photonically-sensitive material. Different types of photonically-sensitive materials are available which can be used to implement the active screen 300. For example, the active regions 304 may use a material that is sensitive to ultraviolet light so that it fluoresces in the visible band upon exposure to ultraviolet light. Accordingly, a visible image formed on the screen may be augmented or modified by the addition of additional visible light from fluorescence of the active screen in response to the non-visible ultraviolet light projected thereon.

As another example, a photonically sensitive material may undergo a reversible chemical reaction when illuminated by the non-visible image to change from a first optical state to a second optical state. The chemical reaction may be metastable. Reversion from the second optical state to the first optical state may occur spontaneously with the passage of time, may be triggered by illumination by a different type of non-visible radiation, or may be triggered by control electronics within the screen (e.g., the application of a voltage or current to the active region). It some embodiments, it may be desirable for the reaction to rapidly reverse, for example, where the projected image is formed by a scanning light beam, with a reversing time less than the dwell time for the scanning.

Various photochromic materials can be included in the active screen regions. In general, photochromic materials are materials for which light can induce a transformation between two forms having different optical characteristics. Transformation may occur in the nanostructure or molecular structure in response to the optical stimulus. Photochromic materials include, for example, spiropyran and spiropyran based compounds. Other photochromic materials can include triarylmethanes, stilbenes, azastilbenes, nitrones, fulgides, spiropyrans, naphthopyrans, and the like.

As another example, the active regions 304 may include a material that is photorefractive, in that the refractive index varies as a function of incident radiation. These changes in the refractive index can thus be used, for example, to vary the scattering angular profile as a function of the incident non-visible light. Photorefractive materials include barium titanate (BaTiO₃), lithium niobate (LiNbO₃), some semiconductor materials, some photopolymers, and the like. As another example, the active regions may include retroreflecting spheres made at least partially from photorefractive material so that the angular response of the screen can be tuned based on the incident non-visible light.

As other examples, the active regions 304 may include a material for which the spectral reflectance can be tuned. For example, the visible image may include primarily white light, or wide bandwidth light components, and the desired color of the image on the screen be determined by using the non-visible light to control the reflected (or transmitted) color provided by the regions.

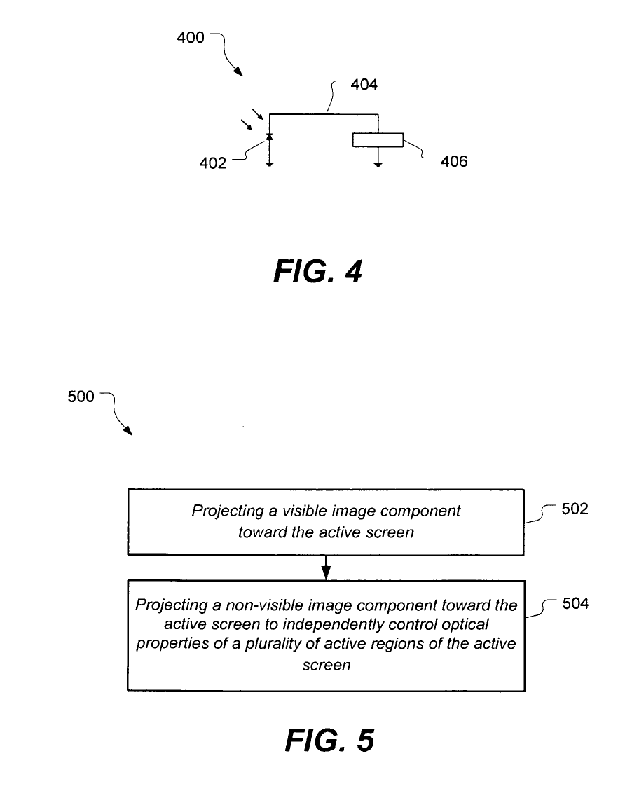

As another example, the active regions 304 may use opto-electric conversion to convert the incident non-visible light into a form to modify to optical property of the active region. For example, FIG. 4 illustrates an active pixel in accordance with another embodiment of the present invention. The active pixel 400 includes a non-visible light detector 402. The non-visible light detector can be, for example a photodiode or phototransistor. The non-visible light detector outputs an electrical signal 404 based on an optical characteristic of non-visible light incident on the non-visible light detector. The non-visible light detector is coupled to an electrically alterable material 406. The electrically alterable material is responsive to the electrical signal to alter an optical property of the electrically alterable material. For example, the electrically alterable material may include compounds as used for so-called electronic ink, liquid crystal materials, field-switchable molecules, and the like.

As another example, the non-visible light detector 402 may include a decoder to decode control information modulated onto the incident non-visible light. The control information may specify the desired optical property of the electrically alterable material, and the electrically alterable material adjusted accordingly.

Finally, a method of modifying a visible projected image using non-visible light to control optical properties of an active screen is shown in flowchart form in FIG. 5. The method 500 includes the step of projecting 502 a visible image component toward the active screen. The visible image component may include, for example, a two-dimensional array of pixels. The method may also include the step of projecting 504 a non-visible image component toward the active screen. The non-visible image component may be capable of directly interacting with the active screen to modify an optical property of the active screen. For example, as described above, the non-visible image component may include light having characteristics in intensity, wavelength, duty cycle, or a combination thereof not perceptible by a human observer. The non-visible image component may cause an electrical or chemical response in the active screen which causes reflectance, transmittance, or other optical properties of the screen to be altered.

Summarizing and reiterating to some extent, a technique for improving the quality of projected images has been invention. The technique includes projecting both a visible image component and a non-visible image component toward an active screen. The active screen is responsive to the non-visible image component, allowing the optical properties of the screen to be adjusted to enhance the appearance of the visible image component. This adjustment may be performed on a per pixel basis. Benefits can include increased contrast, brighter white levels, darker dark levels, increased color gamut, and improved viewing angle. While the foregoing discussion has illustrated examples of the invention principally within the context of front projection, it will be appreciated that similar benefits can be obtained when using a screen in rear projection.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

What is claimed is:

1. A projector providing enhanced imaging capabilities by modifying a projected image using non-visible light to control optical properties of independent active regions of an active screen onto which the image is projected, the projector comprising:
a visible image projection subsystem to project a visible image toward an active screen; and
a non-visible image projection subsystem aligned with the visible image projection subsystem to project a non-visible image toward the active screen, the non-visible image capable of directly interacting with the active regions of the active screen to independently modify optical properties of the active regions under control of the non-visible image.

2. The projector of claim 1, wherein the non-visible image projection subsystem comprises a light source chosen from the group of light sources consisting of an ultraviolet source and an infrared source.

3. The projector of claim 1, wherein the visible image and the non-visible image are each formed from a plurality of corresponding pixels.

4. The projector of claim 1, wherein the active regions correspond to individual pixels of the visible image.

5. An active screen capable of modifying a visible projected image appearance under control of a non-visible control image incident thereon, the active screen comprising:
a screen support structure;
a plurality of active regions coupled to the screen support structure in a substantially two-dimensional array, the active regions each being responsive to non-visible light incident thereon to independently change an optical property of the active region based on an optical characteristic of the non-visible light incident on the active region.

6. The active screen of claim 5, wherein at least one of the active regions comprises a photonically-sensitive material.

7. The active screen of claim 5, wherein at least one of the active regions comprises a photochromic material.

8. The active screen of claim 5, wherein at least one of the active regions comprises:
a non-visible light detector to output an electrical signal based on an optical characteristic of non-visible light incident on the non-visible light detector; and
an electrically alterable material coupled to the non-visible light detector and being capable of altering an optical property of the electrically alterable material based on the electrical signal.

9. The active screen of claim 8, wherein the non-visible light detector further comprises a decoder to decode control information modulated onto the incident non-visible light and output the electrical signal based on the control information.

10. The active screen of claim 5, wherein at least one of the active regions is sensitive to an optical characteristic chosen from the group consisting of ultraviolet intensity, infrared intensity, polarization, and phase.

11. A method of modifying a visible projected image using non-visible light to control optical properties of an active screen, the method comprising:
projecting a visible image component toward the active screen; and
projecting a non-visible image component toward the active screen to independently control optical properties of a plurality of active regions of the active screen.

12. The method of claim 11, wherein the optical property is selected from the group of optical properties consisting of spectral reflectance, spectral transmittance, and scattering profile.

13. The method of claim 11, further comprising modifying the optical property of an active region based on an optical characteristic of the non-visible image incident on the active region.

14. The method of claim 11, wherein the optical characteristic is selected from the group of optical characteristics consisting of spectral intensity, phase, and polarization.

15. The method of claim 11, wherein the non-visible image component includes infrared radiation.

16. The method of claim 11, wherein the non-visible image component includes pulsed energy within the wavelength range of 300 nm to 700 nm having a duty cycle sufficiently low so that the energy is not visually perceptible by a human observer.

17. The method of claim 11, wherein the non-visible image is coded to communicate control information to the active screen.

18. The method of claim 11, wherein the non-visible image includes a plurality of non-visible pixels corresponding to pixels of the visible image,

19. The method of claim 11, further comprising individually controlling pixels of the visible image via optical characteristics of the non-visible pixels selected for interaction with the active screen.
